(19) United States
(12) Patent Application Publication
(10) Pub. No.: US 2011/0193810 A1
(43) Pub. Date: Aug. 11, 2011

(54) TOUCH TYPE DISPLAY APPARATUS, SCREEN DIVISION METHOD, AND STORAGE MEDIUM THEREOF

(75) Inventors: Min-jung PARK, Suwon-si (KR); Joon-hwan Kim, Yongin-si (KR); Soung-min Yoo, Suwon-si (KR); Yeon-hee Roh, Seoul (KR)

(73) Assignee: Samsung Electronics Co., Ltd., Suwon-si (KR)

(21) Appl. No.: 13/023,174

(22) Filed: Feb. 8, 2011

(30) Foreign Application Priority Data
Feb. 8, 2010 (KR) 10-2010-0011478

(51) Int. Cl. G06F 3/041

(52) U.S. Cl. 345/173

(57) ABSTRACT

A touch type display apparatus is provided that includes a memory for storing at least one application, a processor for dividing a screen based on a number of users and for controlling display of an application executed for each divided screen, and a touch screen unit controlled by the processor for displaying data based on the application executed for each divided screen.

### PRIORITY

This application claims priority under 35 U.S.C. §119(a) to Korean Patent Application No. 10-2010-0011478, which was filed on Feb. 8, 2010, in the Korean Intellectual Property Office, the disclosure of which is incorporated herein by reference.

### BACKGROUND OF THE INVENTION

1. Field of the Invention

The present invention relates to a touch type display apparatus, and more particularly, to a touch type display apparatus capable of dividing a screen, a method of dividing a screen in a touch type display apparatus, and a storage medium thereof.

2. Description of the Related Art

Touch type display apparatuses are commonly referred to as touch screens. The touch type display apparatus is a combination of a display device such as a Liquid Crystal Display (LCD), a Light Emitting Diode (LED), or a Cathode Ray Tube (CRT), and a touch panel. A touch type display apparatus is widely used as an interface for bank Automated Teller Machines (ATMs), unmanned ticket issuing machines, mobile phones, MP3 players, navigation systems, televisions (TVs), monitors, game consoles, and Personal Digital Assistants (PDAs), and its application field continues to gradually increase.

As the size of a display device increases, large-size touch type display apparatuses are being introduced. Multiple users may be able operate the large-size touch type display apparatus at the same time. However, even when multiple users simultaneously operate the touch type display apparatus, the touch type display apparatus is operated based on an application that is currently displayed. For example, when a satellite image of an area is currently displayed on a touch type display apparatus, multiple users may operate the touch type display apparatus based on the satellite image that is currently displayed.

### SUMMARY OF THE INVENTION

The present invention has been made to address at least the above problems and/or disadvantages and to provide at least the advantages described below. Accordingly, an aspect of the present invention provides a touch type display apparatus capable of dividing a screen on a multi-user basis, a method of dividing a screen in a touch type display apparatus, and a storage medium thereof.

According to one aspect of the present invention, a touch type display apparatus includes a memory that stores at least one application, a processor that divides a screen based on the number of users and controls display of an application executed for each divided screen, and a touch screen unit that is controlled by the processor to display data based on the application executed for each divided screen.

The touch type display apparatus may further include a network interface unit that transceives data via a network. The processor automatically divides the screen according to the number of users and displays data based on the application used by each user of the touch type display apparatus and a user connected via the network interface unit when an online mode is set, and divides the screen based on the pointers generated according to the number of users when an offline mode is set.

According to another aspect of the present invention, a method of dividing a screen in a touch type display apparatus is provided. A screen is divided based on the number of users, and data is displayed based on an application executed for each divided screen.

According to a further aspect of the present invention, a computer readable recording medium is provided having recorded thereon a program for dividing a screen in a touch type display apparatus. The computer readable recording medium executes the steps of dividing a screen based on a number of users, and displaying data based on an application executed for each divided screen.

### BRIEF DESCRIPTION OF THE DRAWINGS

The above and other aspects, features and advantages of the present invention will become more apparent from the following detailed description when taken in conjunction with the accompanying drawings in which:

FIG. 1 is a functional block diagram illustrating a touch type display apparatus, according to an embodiment of the present invention;

FIG. 2 is a flowchart illustrating a method of dividing a screen in a touch type display apparatus, according to an embodiment of the present invention;

FIG. 3 is a flowchart illustrating an example of the screen division operation of FIG. 2, according to an embodiment of the present invention;

FIG. 4 illustrates examples of the screen division of FIG. 3, according to an embodiment of the present invention;

FIG. 5 illustrates an example of a screen for explaining that an application is independently executed on each divided screen, according to an embodiment of the present invention;

FIG. 6 is a flowchart illustrating an example of the screen division operation of FIG. 2, according to another embodiment of the present invention;

FIG. 7 illustrates an example of a screen in which a common use area is assigned, according to an embodiment of the present invention;

FIG. 8 is a flowchart illustrating a change of the size of a divided screen in the method of dividing a screen in a touch type display apparatus, according to an embodiment of the present invention;

FIG. 9 illustrates an example of a screen in which the size of a divided screen is changed, according to an embodiment of the present invention;

FIG. 10 is a functional block diagram illustrating a touch type display apparatus, according to another embodiment of the present invention;

FIG. 11 is a flowchart illustrating a method of dividing a screen in the touch type display apparatus of FIG. 10, according to an embodiment of the present invention;

FIG. 12 illustrates examples of the screen division of FIG. 11, according to an embodiment of the present invention; and

FIG. 13 is a flowchart illustrating an operation when a common use for a display area is requested in the method of dividing a screen in the touch type display apparatus of FIG. 10, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated indifferent drawings. Detailed descriptions of constructions or processes known in the art may be omitted to avoid obscuring the subject matter of the present invention.

FIG. 1 is a functional block diagram illustrating a touch type display apparatus 100, according to an embodiment of the present invention. The touch type display apparatus 100 may be used as an interface for Personal Computers (PCs) with a touch panel, bank ATMs, unmanned ticket issuing machines, mobile phones, MP3 players, navigations, TVs, monitors, game consoles, or PDAs, but not limited thereto. Also, the touch type display apparatus 100 may be a large-size display apparatus.

Referring to FIG. 1, the touch type display apparatus 100 includes a touch screen unit 110, a processor 120, and a memory 130. The touch screen unit 110 includes a touch panel 111 and a display device 112. The touch panel 111 is a touch based input unit using a finger or a dedicated pen and is installed on the display device 112. However, the touch base of the touch panel 111 is not limited to the finger or dedicated pen. The display device 112 may be an LCD, an LED, or a CRT, but is not limited thereto.

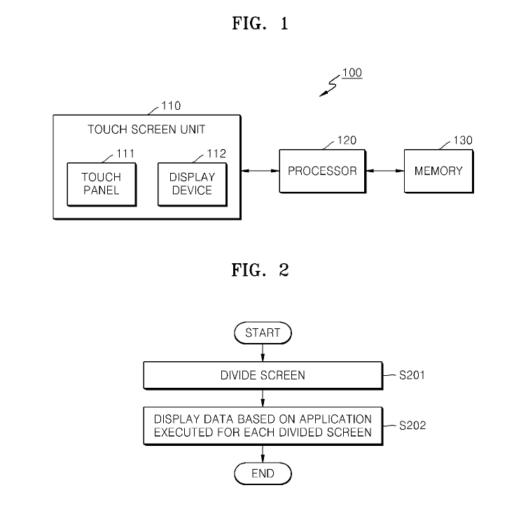

The processor 120 controls all functions of the touch type display apparatus 100. In particular, the processor 120 divides a screen based on the number of users of the touch type display apparatus 100 and controls display of an application executed in units of divided screens. Specifically, the processor 120 may operate as illustrated in FIG. 2.

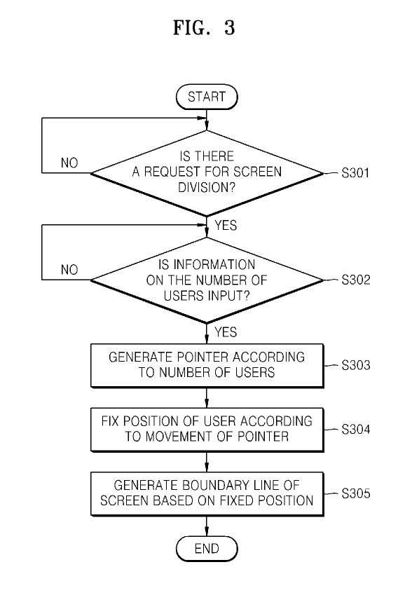

FIG. 2 is a flowchart illustrating a method of dividing a screen in a touch type display apparatus, according to an embodiment of the present invention. Referring to FIG. 2, the processor 120 divides a screen of the touch screen unit 110 in step S201. Specifically, the processor 120 divides a screen as illustrated in FIG. 3.

FIG. 3 is a flowchart illustrating an example of the screen division operation of FIG. 2, according to an embodiment of the present invention. Referring to FIG. 3, when a screen division request is received through the touch panel 111 in step S301, the processor 120 determines whether information on the number of users is input in step S302. The screen division request may be input via an input unit. The input unit may include a remote controller and a remote receiver, or a device such as a keyboard or a mouse.

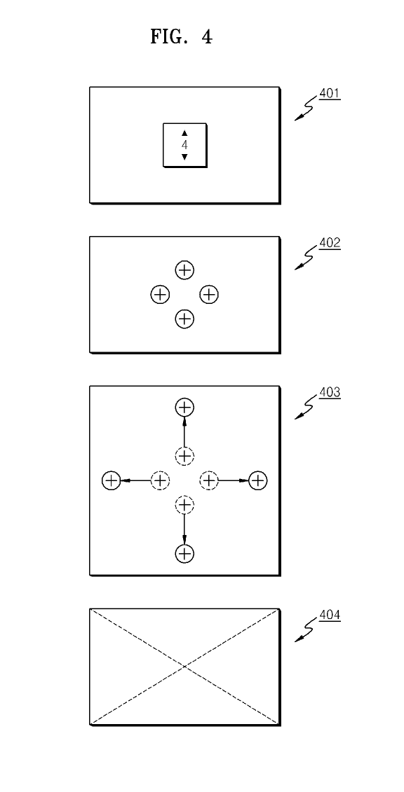

The user number information may be input through the touch panel 111 by using information displayed on the display device 112 as illustrated in 401 of FIG. 4. However, the user number information may be input using the above-described input unit. When the user number information is input, in step 303, the processor 120 generates a pointer according to the user number as illustrated in 402 of FIG. 4. In the case of 401 of FIG. 4, since the input user number information is “4”, four pointers are generated as illustrated in 402 of FIG. 4.

FIG. 4 illustrates examples of the screen division according to the flowchart of FIG. 3. When each user touches any one of the generated pointers and moves the pointer in the directions as illustrated in 403 of FIG. 4, the processor 120 fixes the position of the users in step S304. Specifically, when it is determined that the generated pointer is touched and dragged by a user and held without a movement for a predetermined time according to an event generated from the touch panel 111, the processor 120 outputs a message asking whether to fix the position to the display device 112. When a message for confirming the position fixing based on the output message is input through the touch panel 111, the processor 120 fixes the position where the pointer is stopped after drag, as a position by a user.

In step S305, the processor 120 generates boundary lines on the divided screen based on the fixed positions. When the positions of the users fixed by the pointers are as shown in 403 of FIG. 4 and the number of users is 4, the boundary lines of the divided screens may be generated as illustrated in 404 of FIG. 4. The processor 120 generates the boundary lines of the divided screens such that the fixed position can be the center if possible.

Referring again to FIG. 2, when the screen is divided as described above, the processor 120 displays data based on an application that is executed for each screen divided in step S202. The executable application may be an application for program information view, detailed information view, content search, game, shopping, or dictionary, but not limited thereto. The application may be selected before an embodiment of the present invention is performed, or selected by each user after the screen division.

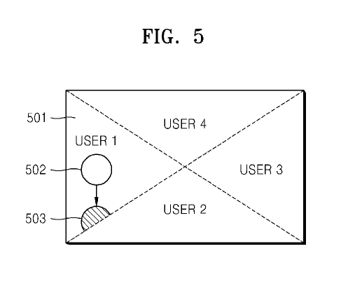

The processor 120 independently operates an application executed on each divided screen. Thus, as illustrated in FIG. 5, when a user 1 moves data displayed by an application that is executed in a display area 501 from a position 502 to a position 503 crossing a boundary line between the user 1 and a user 2, a portion of the data crossing the boundary line is displayed as being cut off. FIG. 5 illustrates an example of a screen illustrating that an application is independently executed on each divided screen, according to an embodiment of the present invention.

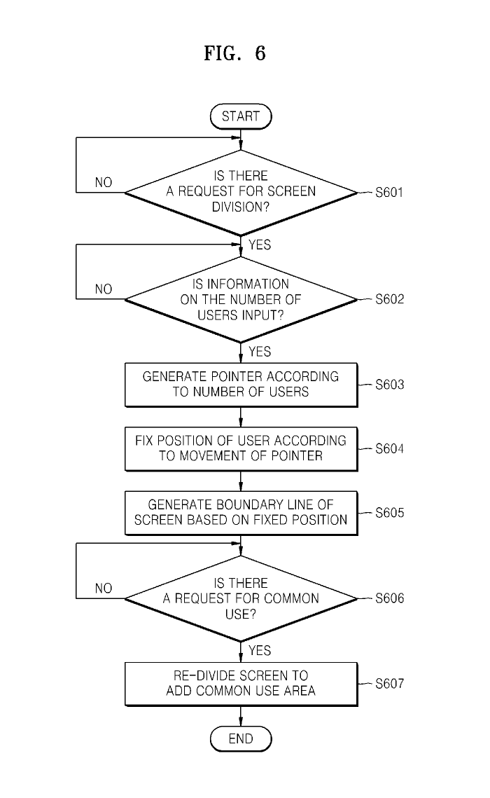

The processor 120 may also operate the screen division as illustrated in FIG. 6. FIG. 6 is a flowchart illustrating an example of the screen division operation of FIG. 2, according to another embodiment of the present invention. Steps S601 to S605 of FIG. 6 are identical to steps S301 to S305 of FIG. 3, and their descriptions are omitted herein.

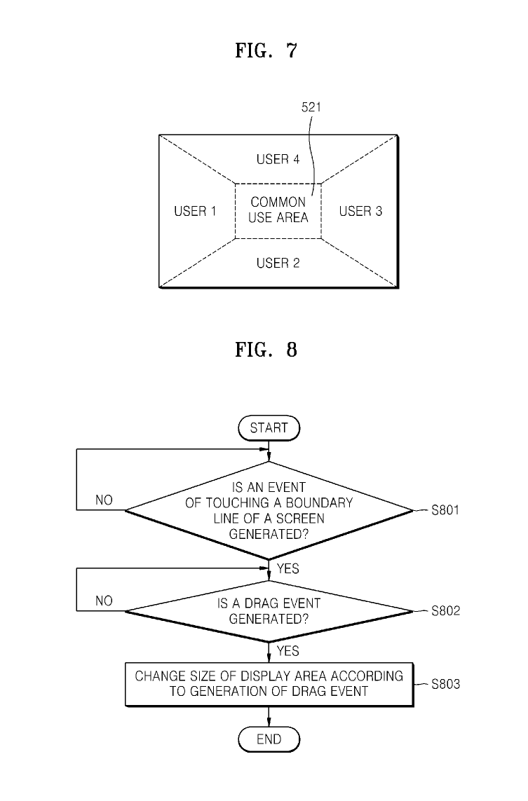

As described with reference to FIG. 6, it is determined whether at least one user requests a common use of at least one application. The processor 120 re-divides the screen to add a display area for multiple users to use in step S607. Specifically, as illustrated in FIG. 7, the screen may be re-divided such that a common use area 521 can be assigned at the center portion of the screen. FIG. 7 illustrates an example of a screen in which a common use area is assigned, according to an embodiment of the present invention. The common use area 521 may be set at the center portion of the screen as illustrated in FIG. 7 as default. However, the common use area may be set by a user who requested the generation of a common use area. For example, when a user wants to use his or her display area as the common use area, the processor 120 may set the display area of the user as the common use area without re-dividing the screen. The common use of an area may be requested by using data displayed in a display area assigned for each user.

The processor 120 may change the size of a divided screen as illustrated in FIG. 8. FIG. 8 is a flowchart illustrating a change of the size of a divided screen in the method of dividing a screen in a touch type display apparatus, according to an embodiment of the present invention.

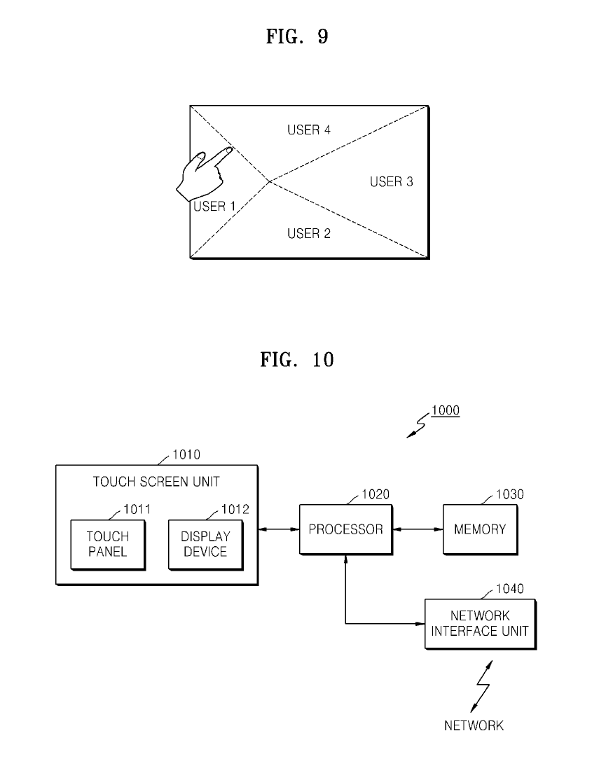

Referring to FIG. 8, when the screen is divided and an application is executed in each divided area, if at least one user generates an event by touching a boundary line on the touch panel 111 in step S801, the processor 120 checks whether a drag event is generated on the touched boundary line in step S802. If it is determined that a drag event is generated, the processor 120 changes the size of the divided screen according to the generation of a drag in step S803. Specifically, as illustrated in FIG. 9, when the user 1 drags while touching the boundary line of the user 1, the processor 120 may change all of the sizes of the divided screens according to drag direction and drag distance. FIG. 9 illustrates an example of a screen in which the size of a screen is changed according to an embodiment of the present invention.

The memory 130 of FIG. 1 stores at least one application and data needed when the processor 120 controls a touch type display apparatus. The application stored in the memory 130 may have a multimedia file format.

FIG. 10 is a functional block diagram of a touch type display apparatus 1000, according to another embodiment of the present invention. The touch type display apparatus 1000 may be used in PCs with a touch panel capable of network connection, TVs with a touch panel capable of network connection, an interface with a touch panel in ATMs capable of network connection, unmanned ticket issuing machines with a touch panel capable of network connection, mobile phones with a touch panel capable of network connection, MP3 players with a touch panel capable of network connection, navigations with a touch panel capable of network connection, monitors with a touch panel capable of network connection, game consoles with a touch panel capable of network connection, or PDAs with a touch panel capable of network connection, but is not limited thereto. Also, the touch type display apparatus 1000 may be a large-size display apparatus.

Referring to FIG. 10, the touch type display apparatus 1000 includes a touch screen unit 1010 (having a touch panel 1011 and a display device 1012), a processor 1020, a memory 1030, and a network interface unit 1040. Since the touch screen unit 1010 is the same as the touch screen unit 110 of FIG. 1, a detailed description thereof is omitted herein. The memory 1030 may store information stored in the memory 130 of FIG. 1 and data needed for the operation of the network interface unit 1040 or generated according to the operation.

The processor 1020 controls all functions of the touch type display apparatus 1000 and includes the functions of the processor 120 of FIG. 1 and a function according to a network connection. To avoid repetition of a description, a description on the functions of the processor 120 of FIG. 1 is omitted and the function of the processor 1020 according to the network connection is described in greater detail below.

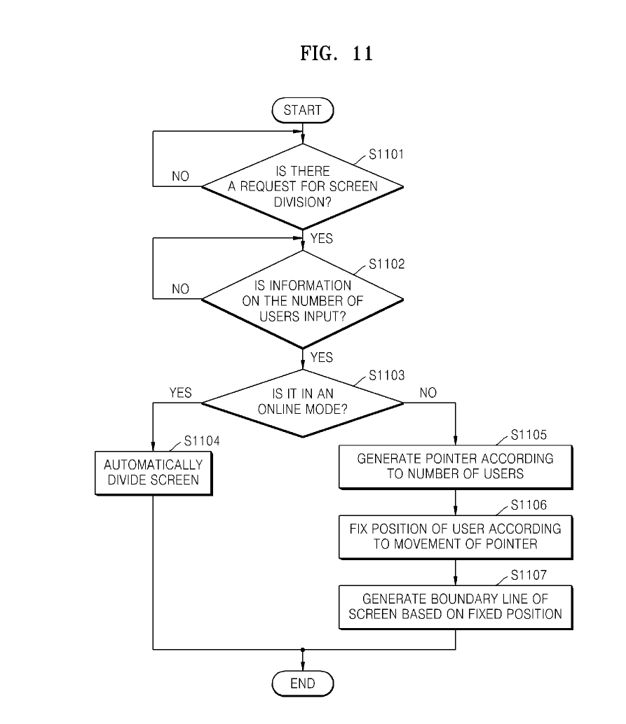

The processor 1020 operates as illustrated in FIG. 11. FIG. 11 is a flowchart illustrating a method of dividing a screen in the touch type display apparatus 1000 of FIG. 10. Referring to FIG. 11, steps S1101 and S1102 are identical to step S301 and S302 of FIG. 3.

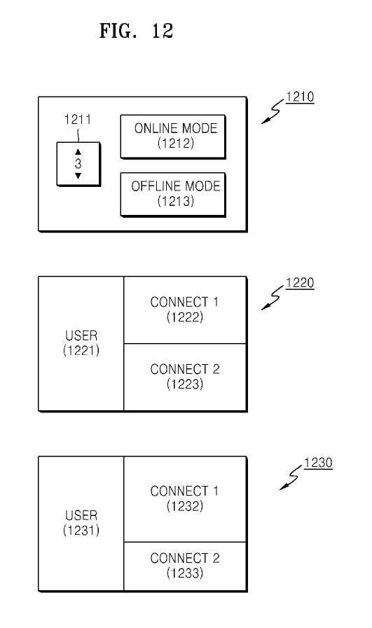

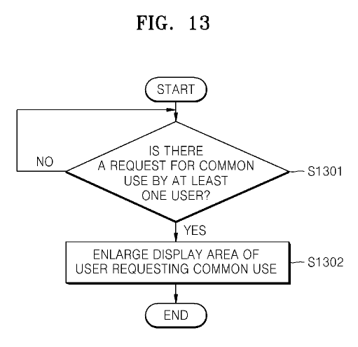

After information on the number of users is input, in step S1103, the processor 1020 outputs a query regarding whether to set an online mode or an offline mode as illustrated in 1210 of FIG. 12. An online mode is set by touching area 1212 of 1210, while an offline mode is set by touching area 1213 of 1210. Further, the number of users is set by touching 1211 of 1210. When an online mode is set, in step S1104, the processor 1020 automatically divides the screen as illustrated in 1220 of FIG. 12. In 1220 of FIG. 12, the screen is divided into a display area 1221 for a user of the touch type display apparatus 1000, and CONNECT 1 1222 and CONNECT 2 1223, which are display areas for users connected via a network.

When a user sets an offline mode in step S1103 of FIG. 11, the processor 1020 performs steps S1105 to S1107, which are identical to steps S303 to S305 of FIG. 3.

For the screen divided in an online mode, when at least one user requests common use for a display area, the processor 1020 operates as illustrated in FIG. 13. FIG. 13 is a flowchart illustrating an operation when a common use for a display area is requested in the method of dividing a screen in the touch type display apparatus 1000 of FIG. 10, according to an embodiment of the present invention.

Referring to FIG. 13, when a request of common use for his or her display area by at least one user is received in step S1301, the processor 1020 enlarges the display area of a user who requests the common use in step S1302, as illustrated in 1230 of FIG. 12. Specifically, 1230 of FIG. 12 shows that CONNECT 1 1222 of 1220 is enlarged to CONNECT 1 1232 of 1230 when the user of CONNECT 1 who is connected via a network requests common use for his or her display area. The size of CONNECT 1223 of 1220 is decreased to CONNECT 1233 of 1230, and a display area for the user 1221 of 1220 is the same as the display are 1231 of 1230. The request of common use for a display area is performed by using data displayed in a display area assigned for each user.

A program to execute a method of dividing a screen according to an embodiment of the present invention can also be embodied as computer readable codes on a computer readable recording medium. The computer readable recording medium is any data storage device that can store data, which can be thereafter read by a computer system. Examples of the computer readable recording medium include Read-Only Memory (ROM), Random-Access Memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been shown and described with reference to certain embodiments thereof, it will be understood by those skilled in the art that various changes in form and detail may be made therein without departing from the spirit and scope of the invention as defined by the appended claims and any equivalents thereof.

What is claimed is:

1. A touch type display apparatus comprising:
a memory that stores at least one application;
a processor that divides a screen based on a number of users, and that controls display of an application executed for each divided screen; and
a touch screen unit that is controlled by the processor to display data based on the application executed for each divided screen.

2. The touch type display apparatus of claim 1, wherein the processor generates a number of pointers according to the number of users, fixes a position of each user according to a movement of a corresponding pointer, and divides the screen by generating at least one boundary line in accordance with which the screen is divided based on a fixed position of each user.

3. The touch type display apparatus of claim 2, wherein the processor independently operates the application executed for the divided screen.

4. The touch type display apparatus of claim 2, wherein, when an event of touching the at least one boundary line is generated and a drag event is generated on the at least one boundary line, the processor changes sizes of each divided screen according to the generated drag event.

5. The touch type display apparatus of claim 1, wherein, when at least one of a plurality of users requests common use of the application, the processor re-divides the screen to add a display area for common use by the plurality of users.

6. The touch type display apparatus of claim 2, further comprising a network interface unit that transceives data via a network,
wherein the processor automatically divides the screen according to the number of users and displays data based on the application used by each user of the touch type display apparatus and a user connected via the network interface unit when an online mode is set, and divides the screen based on the pointers generated according to the number of users when an offline mode is set.

7. The touch type display apparatus of claim 6, wherein, when at least one of the users requests common use for his or her display area in the online mode, a size of the display area of the user who requests the common use is enlarged.

8. A method of dividing a screen in a touch type display apparatus, the method comprising the steps of:
dividing a screen based on a number of users; and
displaying data based on an application executed for each divided screen.

9. The method of claim 8, wherein dividing the screen comprises:
generating a number of pointers according to the number of users;
fixing a position of each user according to a movement of a corresponding pointer; and
dividing the screen by generating at least one boundary line in accordance with which the screen is divided based on a fixed user position.

10. The method of claim 9, wherein dividing the screen further comprises changing sizes of each divided screen according to generation of a drag event to the at least one boundary line after an event of touching the at least one boundary line is generated.

11. The method of claim 8, wherein displaying data comprises independently operating the application executed for each divided screen.

12. The method of claim 8, wherein dividing the screen further comprises re-dividing the screen to add a display area for common use by a plurality of users when at least one of the plurality of users requests common use of the application.

13. The method of claim 9, wherein dividing the screen further comprises:
automatically dividing the screen according to the number of users when an online mode is set; and
displaying data based on an application used by each user of the touch type display apparatus and a user connected via a network, by using the automatically divided screen; and
dividing the screen based on a generated pointer when an offline mode is set.

14. The method of claim 13, wherein the dividing of a screen further comprises enlarging a size of his or her display area of at least one of the plurality of users who requests common use for the display area in the online mode.

15. A computer readable recording medium having recorded thereon a program for dividing a screen in a touch type display apparatus, the computer readable recording medium executing the steps of:
dividing a screen based on a number of users; and
displaying data based on an application executed for each divided screen.
